(19) United States
(12) Patent Application Publication
(10) Pub. No.: US 2004/0252670 A1
(43) Pub. Date: Dec. 16, 2004

(54) Adaptive power margin adjustment for a 1xEV-DV system

(75) Inventors: Zhigang Rong, Irving, TX (US); Lin Ma, Irving, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/461,838

(22) Filed: Jun. 12, 2003

(51) Int. Cl. H04J 1/00

(52) U.S. Cl. 370/343

(57) ABSTRACT

A method for adaptively adjusting power margin over a forward control channel PDCCH from a base station BS to a mobile station MS during a call. Corresponding message packets are sent in parallel over PDCCH and a data channel PDCH to an MS. The BS monitors a reverse channel ACKCH for an expected reply from the MS. If the reply is ACK, the power margin for the next subsequent transmission on PDCCH is lowered. If the reply is NACK, the power margin for the next subsequent transmission on PDCCH is lowered. If no reply is timely received, the power margin for the next subsequent transmission on PDCCH is raised. If the method is applied also to PDCH, an ACK reply causes the power margin on PDCH to decrease; a NACK reply causes the power margin on PDCH to increase, and no reply leaves the power margin on PDCH unchanged.

### TECHNICAL FIELD

These teachings relate generally to channel power control in a CDMA system. It is particularly directed to power control over the packet data control channel and packet data channel on the forward link, though not limited only to that channel or direction.

### BACKGROUND

The goal of second generation (2G) networks (e.g., IS-95) was to enable pre-defined mobile telephony services that were spectrum efficient and economically viable. The result was a network that provided mobile low rate circuit switched voice communications and low rate data communications. The success of 2G is evidenced by consumer acceptance and popularity that exceeded expectations. As more consumers used mobile radiotelephone services, certain increasing numbers of them manifested a desire for more capacity in both voice and data. The cellular industry responded with 3G (e.g., cdma2000), the next generation that introduced packet switched data networks.

CDMA, or code-division multiple access, is a highly efficient use of radio spectrum based on a spread spectrum technique. In the CDMA method, a narrow band voice or data signal is multiplied over a relatively wide band by a spreading code, generally termed a Walsh-Hadammard code or a Walsh code. In short, the narrow band signal is divided into “packets” that are each inserted into one or more “slots”, each slot defined by time and frequency boundaries. The packets may be spread over the entire available bandwidth, so the initial narrow band signal to be sent is actually transmitted over a much wider bandwidth, leading to the term spread spectrum. A base station of a wireless service provider generally serves multiple users at once. While certain slots may be temporarily dedicated to one user or mobile station, other slots are available for use by other mobile stations.

One limitation of CDMA is that the base station (BS) is sensitive to different power levels transmitted by different mobile stations (MS). Where two MSs transmit a signal at the same power level, one very close to the BS will sometimes render the BS unable to recognize a signal from the other MS located at the outskirts of the base station's geographical cell due to power losses from propagation. At the least, differential power levels by different MSs prevents the maximization of available bandwidth. Power levels must therefore be strictly controlled among the MSs served by a single BS.

Generally, there are two techniques by which power control is effected in a CDMA system: open loop and closed loop. In open loop power control, each MS measures the strength of the signal it receives from the BS and adjusts its transmitting power on the basis of the received signal power. In closed loop power control, the BS measures the strength of the signal received from the MS and transmits power control messages to the MS. The MS then uses these affirmative power control messages to adjust its next transmit power level. Both techniques may be used simultaneously.

Recent industry trends indicate an increasing flow of data over wireless channels, especially in the forward or downlink (BS to MS) direction. However, the majority of revenues to most wireless service providers remain driven by voice communications. Further infra-structure improvements thus needed to address the demand for increased data traffic without sacrificing quality of service for voice communications that occur simultaneously over the same radio-frequency (RF) carrier. A standard known as 1×EV-DV (also known as cdma2000, revision C) seeks to meet those goals in allowing wireless operators to utilize their spectrum more efficiently and to balance the voice and data traffic based on the needs of the individual operators.

1×EV-DV introduces a number of new features to the cdma2000 air interface architecture. One key feature is higher forward link capacity to yield average forward data rates of up to 3.1 Mbps and average sector throughputs of about 1 Mbps. 1×EV-DV achieves these data rates though adaptive modulation coding schemes (AMC), hybrid automated repeat request (H-ARQ) to the physical frame layer, and defining a new forward link data traffic channel called packet data channel (PDCH). PDCH provides both time-division multiplexing and code-division multiplexing treatments to data transmitted on it. PDCH is shared by packet data users and cannot undergo soft handoff (SHO). Depending upon system loading as determined by the individual wireless operator, the PDCH consists of one to twenty-eight code-division multiplexed quadrature Walsh sub-channels, each spread by a 32-ary Walsh function. It can transmit packets in fixed sizes of 408, 792, 1560, 2328, 3096, and 3864 bits, and the system has variable packet durations of 1.25, 2.5, and 5.0 milliseconds (ms). Alongside the PDCH is the packet data control channel (PDCCH), which contains control information for the PDCH. PDCH and PDCCH are forward channels only, and are sometimes termed F-PDCH and F-PDCCH, respectively.

The control information on the F-PDCCH is important to the operation of F-PDCH and comprises parameters such as the user's medium access control identification (MAC ID, an eight-bit identifier to match transmissions to a particular mobile station during a call), encoder packet size, number of slots per sub-packet, hybrid automatic repeat-request (H-ARQ) control information, and last Walsh code index. This control information is carried in 37-bit packets, transmitted over the same packet duration as the corresponding PDCH packets. A general overview is shown in FIG. 1. When the BS 20 sends a signal to the MS 22, it transmits on the F-PDCCH 24 and the F-PDCH 26 in parallel. On the receiving side, the MS 22 first demodulates and decodes the signal on the F-PDCCH 24, and determines if the transmission is intended for itself by checking whether the MAC ID carried on the F-PDCCH 24 matches its own MAC ID. If a match is found, the MS demodulates and decodes the signal on the F-PDCH 26 based on the control information carried on the F-PDCCH 24. A successful signal transfer requires correct reception of signals on both the F-PDCCH 24 and F-PDCH 26 at the MS 22.

When both the F-PDCCH 24 and F-PDCH 26 are received correctly, the MS 22 transmits an Acknowledgement message (ACK) on the Reverse Acknowledgement Channel (R-ACKCH) 28 indicating to the BS 20 a successful reception of the data packet. If errors occur, the MS 22 operates differently on the R-ACKCH 28 depending on which channel 24, 26 is corrupted:

If the F-PDCCH 24 is in error, the MS 22 assumes that the corresponding F-PDCH 26 is directed to other users (other MSs), and transmits nothing on the R-ACKCH 28.

If the F-PDCCH 24 is received correctly whereas the F-PDCH 26 is in error, the MS 22 sends a Negative Acknowledged message (NACK) on the R-ACKCH 28 to indicate to the BS 20 that the data packet is in error.

Upon detecting no ACK transmitted from the MS 22 (which may be a NACK or an absence of a message on the R-ACKCH within a prescribed time period), the BS 20 can retransmit the data packet. The MS 22 combines the retransmission with the previous transmissions and performs the decoding of the data packet again. The ultimate error rate can be decreased through retransmission. However, for some applications such as voice over internet protocol (VoIP), retransmission of the error packet might not be viable, and the quality of the service (QoS) relies solely on the first transmission. QoS is often indicative of a certain maximum error rate, such as a bit error rate, a block error rate, or a packet error rate, depending upon the particular type of system, channel, and/or data. Where re-transmission is not available to improve QoS, the packet error rate can be no lower than the higher of either the F-PDCCH Block Error Rate (BLER) or the F-PDCH packet error rate (PER).

In the inventors' review of forward links under 1×EV-DV, the wireless operator of the BS 20 generally ensures a particular QoS by stipulating a targeted BLER for the F-PDCCH 24 and a targeted PER for the F-PDCH 26. Based on the targeted BLER, PER, and a carrier-to-interference ratio (C/I) report from the MS 22, the BS 20 decides the transmission power of the F-PDCCH 24 and the transmission format of the F-PDCH 26. In order to ensure that the BLER of the F-PDCCH 24 is close to its targeted BLER, the prior art generally applies a power margin when determining the transmission power of signals on the F-PDCCH 24. For CDMA systems generally, a BS 20 determines a transmission power level based on several factors. One of those factors is termed a power margin, which is typically added to or subtracted from a value determined from the other factors such as channel quality (which is transmitted from the MS 20). As such, a positive (or negative) change in power margin may not necessarily result in a positive (or negative) change in transmitted power level, depending upon the other factors. Power margin is specifically used to account for the C/I inaccuracy caused by variables such as channel variation, C/I report delay, C/I measurement error, and C/I quantization error.

In the inventors' review of forward links under 1×EV-DV, the power margin is fixed for the entire transmission, and may be different for various channel environments and slot duration of the F-PDCCH 24 (assuming the channel environment can be detected correctly). Additionally, the slot duration of the F-PDCCH 24 could be 1, 2, or 4 slots. Thus for each channel environment, three power margins need to be specified, one for each slot duration. The prior art assumes that the channel environment can be detected correctly and a look-up table consisting of the power margins for combinations of different channel environment and slot duration is available for searching for the appropriate value. The present invention is directed toward more precise power management of transmission, especially transmissions from the base station, in a spread spectrum environment. Better power management should yield improved error rates as described below.

### SUMMARY OF THE INVENTION

In accordance with the present invention, power margin of transmissions sent over a control channel, such as the F-PDCCH of 1×EV-DV, is adaptively adjusted during a call based on the content of received signals on the R-ACKCH. This is opposed to the prior art technique of adjusting power margins only at the beginning of a call based on the power level of a signal received from the mobile station. After transmitting over a control channel and a data channel, such as in parallel over the F-PDCCH and F-PDCH, to the MS, the BS monitors a reply channel such as R-ACKCH. If the BS detects no reply signal on the reply channel, it increases by an up-step-size the power margin over the control channel for the next subsequent transmission to that MS for that call. If the BS detects a reply on the reply channel, it decreases by a down-step-size the power margin for the next subsequent transmission over the control channel to that MS for that call. The ratio of the up-step-size to the down-step-size is preferably a function of the target BLER of the control channel.

This above method can be extended to a data channel that corresponds to the control channel as follows. Preferably, adaptive power changes for transmissions over the data channel are done only when needed, such as with voice over internet protocol (VoIP) in which retransmission over the data channel is not available. For adjusting the power margin over the data channel, one type of reply message, such as a NACK in accordance with 1×EV-DV, will cause the BS to increase power margin for the next subsequent transmission over the data channel to the MS for that call. Another type of reply message, such as an ACK in accordance with 1×EV-DV, will cause the BS to decrease power margin for the next subsequent transmission over the data channel to the MS for that call. Detection of no reply signal on the reply channel will cause the BS to maintain the data channel power margin unchanged for the next subsequent transmission to that MS for that call.

While described specifically in the context of channels defined by 1×EV-DV, the present invention is a power management tool applicable to any spread spectrum multiplexing system.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a high level block diagram of a wireless communication system showing channels of communication for which the present invention may be employed.

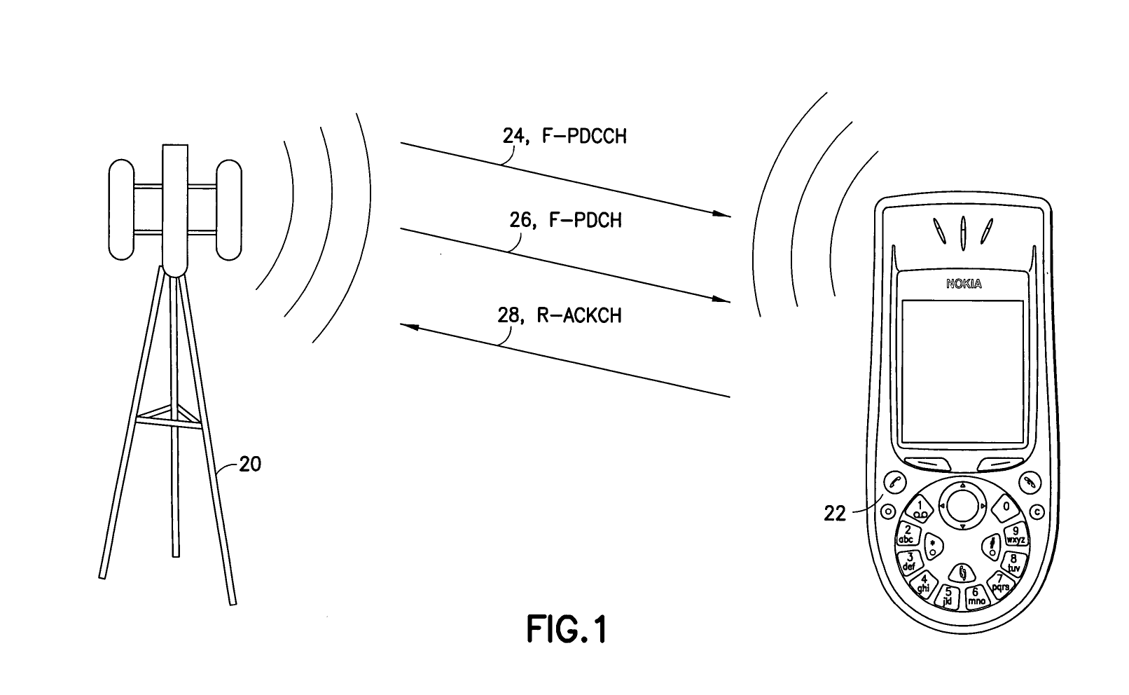

FIG. 2 is a series of graphs depicting the power margin used for power level adjustment of PDCCH and PDCH at the base station in response to transmissions on various channels.

FIG. 3 is a graph of a simulation for PDF of the PDCCH BLER comparing fixed power margins to adaptive power margin adjustments of the present invention.

FIG. 4 is an enlarged portion of the graph of FIG. 3, the portion indicated by the markings on the axes.

FIG. 5 is a logical block diagram depicting a base station configured according to the preferred embodiment of the present invention.

### DETAILED DESCRIPTION OF THE PREFERRED EMBODIMENT

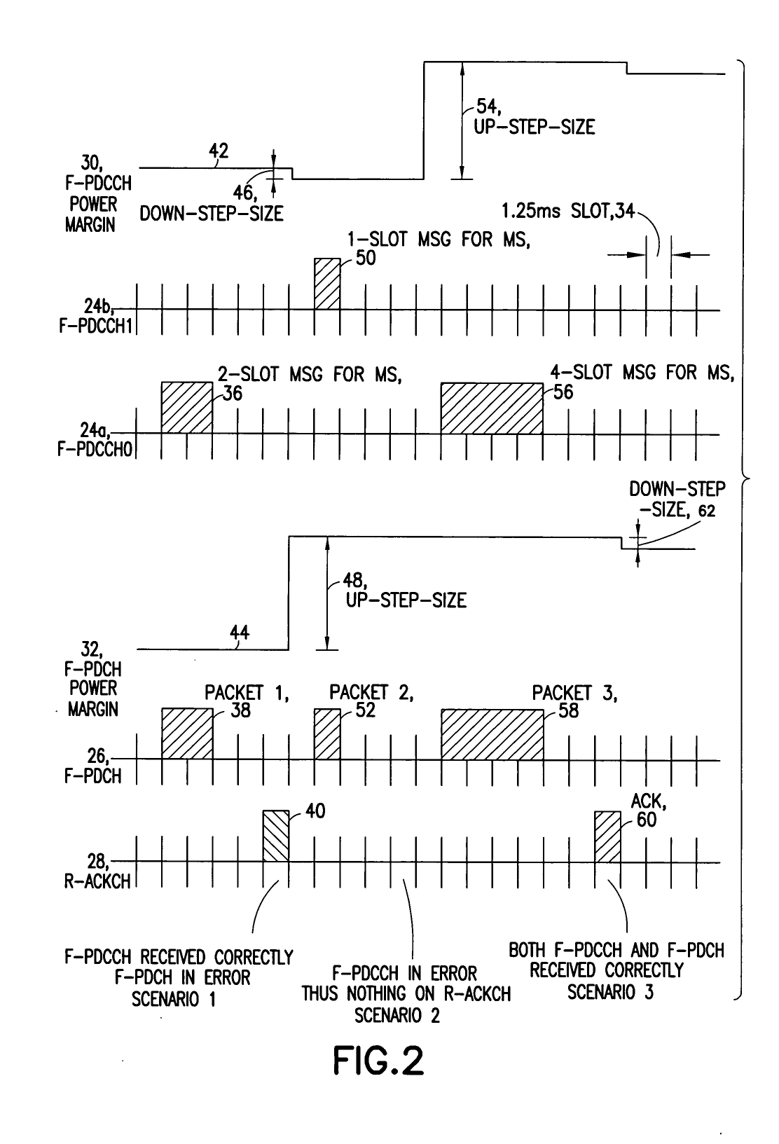

The present invention is best described with reference to graphical representations of signals transmitted over various channels. FIG. 2 depicts a series of graphs showing different activity on the various channels and how they relate to one another. A F-PDCCH Power Margin graph 30 shows the power margin used to adjust the power level of a signal transmitted from the BS 20 over the F-PDCCH 24. Transmitted signals or packets on the F-PDCCH 24 are depicted in two graphs: F-PDCCH1 (reference number 24a) and F-PDCCH0 (reference number 24b), which are logical channels that may together be used as the F-PDCCH 24. In the below description, the F-PDCCH power margin graph 30 applies to both forward control channels 24a and 24b. Alternatively, each of the forward control channels may have their power margin adjusted individually, wherein a response on the R-ACKCH 28 to a signal on one control channel 24a does not result in a power margin adjustment to a subsequent transmission to the same MS 22 over a different control channel 24b.

Preferably, for each individual user, the BS 20 only adjusts a single F-PDCCH power margin, and possibly a single F-PDCH power margin, to avoid the prior art complexity of specifying three power margins on each channel for the three slot durations and keeping different sets of power margins for different channel environments. Ideally, power margin should only be a function of the user's channel environment (e.g., mobile speed, multi-path channel structure, etc.), rather than which control channel it uses. The disadvantage of using separate power margin for separate F-PDCCHs is that the update rate of the power margin for each individual control channel will become slower and less accurate. Furthermore, the base station 20 has to keep and adjust two power margins for one single user, resulting in higher complexity. The above reasoning applies to the power margin for F-PDCH as well. Any of the channels F-PDCCH, F-PDCH, and R-ACKCH may be one or more channels as known in the art. A F-PDCH Power Margin graph 32 shows the power margin used to adjust the power level of a signal transmitted from the BS 20 over the F-PDCH 26. Transmitted signals or packets are also depicted on graphs for the F-PDCH 26 and the R-ACKCH 28. Each of the graphs for the channels 24a, 24b, 26, 28, are divided into slots 34, which for illustration are of duration 1.25 ms. In accordance with spread spectrum techniques, any of the slots 32 may be bounded by different frequency parameters, though the graphs of FIG. 2 illustrate only time boundaries.

Assume for the following description that the BS 20 allows three slots 34 from the end of a packet transmitted on a forward channel 24a, 24b, 26, for the MS 22 to respond on the R-ACKCH 28. The three most likely scenarios for which the present invention adaptively adjusts transmission power over forward channels (from the BS 20) are described separately below. It is important to note that the below description referring to changes in power margins to adjust power level transmitted by the BS to the MS 22 apply only to transmissions to that particular MS 22. A wireless operator may continue to use either or both open loop or closed loop power control in conjunction with the present invention, so an ideal transmission power margin used to adjust power level for one MS 22 may not be appropriate for a different MS within the geographic cell of the same BS 20.

Messages on the control channel are termed one-slot, two-slot, or four-slot messages to distinguish them from one another for description purposes and to avoid confusion, but the present invention operates independent of slot duration of the F-PDCCH. Additionally, the power margin adjustments described below preferably apply to a single call (e.g., a single phone call to the MS 22, a single period of the MS 22 being logged onto a data network such as the internet, or the period of time which a traffic channel is dedicated to communication through the BS 20 to the MS 22), wherein a subsequent call to/from the same MS 22 through the BS 20 uses initialized power levels for channels as in the prior art. Alternatively, the last power level for transmitting from a BS 20 to a MS 22 over a control channel and/or a data channel may be stored by the BS 20 (or by the MS 22 to be transmitted to the BS 20 on call initiation) to be used as the first power margin for a next subsequent call to/from the same MS 22 and passing through the same BS 20.

Scenario 1: NACK Message:

The BS 20 transmits a two-slot message 36 on a control channel 24a and a corresponding packet-1 message 38, also over two slots, on a data channel 26. The BS 20 preferably transmits the two-slot message 36 and the packet-1 message 38 in parallel. The two-slot message 36 is transmitted over the control channel 24a using a first control power margin 42 as shown on the F-PDCCH power margin graph 30. Similarly, the packet-1 message 38 is transmitted over the data channel 26 using a first data power margin 44 as shown on the F-PDCH power margin graph 32. The first control power margin 42 and first data power margin 44 for a call to the MS 22 is preferably initialized in accordance with the prior art.

In accordance with the above background description, the MS 22 receives the two-slot message 36 over the control channel 24a, properly decodes and demodulates it, and determines that the corresponding packet-1 message 38 is directed to it. In this instance, the MS 22 is unable to receive or properly decode/demodulate the packet-1 message 38, and as per 1×EV-DV, transmits a NACK message 40 over the R-ACKCH 28. In accordance with 1×EV-DV, the NACK message 40 indicates to the BS 20 that the MS 22 properly received the transmission on the control channel 24a but did not properly receive the corresponding transmission on the data channel 26. Because the NACK message 40 is transmitted within three slots of the end of the message 34 on the forward link 24a, consistent with the assumption above, the BS 20 properly receives it.

The BS 20 responds preferably by adjusting the power margin for the next subsequent transmission to the same MS 22 over the F-PDCCH 24. If necessary, such as with VoIP where re-transmissions might not be available, the power margin for the next subsequent transmission to the same MS 22 over the F-PDCH 26 is also adjusted. To optimize the system, the BS 20 may adjust power for the next subsequent transmission over only the control channels to which the NACK message 40 relates, over only the data channels, or over only the data channels to which the NACK message 40 relates. The NACK message 40 indicates proper reception (of the message 36) over the control channel used 24a, so the BS 20 decreases the power margin used to send the next subsequent signal sent to that same MS 22 over the control channel 24a (or over any F-PDCCH 24). The extent of the power margin decrement on a control channel 24 is herein termed a control power margin down-step 46. Similarly, the NACK message indicates failure of reception (of the packet-1 message 38) over the data channel 26, so the BS 20 increases the power margin used to send the next subsequent signal sent to that same MS 22 over the data channel 26 (or over any F-PDCH 26) if necessary, such as the example given above. The extent of the power margin increase on a data channel is herein termed a data power margin up-step 48. Preferably, the up-step 48 is larger than a down-step 46. The next subsequent transmission from the BS 20 to that same MS 22 is at the power levels as adjusted based on the power margin in response to the NACK message 40.

Scenario 2: No Message:

In this second scenario, the BS 20 transmits a one-slot message 50 on a control channel 24b and a corresponding packet-2 message 52, also over one slot, on the data channel 26. The BS 20 preferably transmits the one-slot message 50 and the packet-2 message 52 in parallel. Like the other scenarios, the one-slot message 50 is transmitted over the control channel 24b using a control power margin that may or may not be a first or initial control power margin, depending upon whether it is an initial transmission from the BS 20 to the MS 22 for a call or a subsequent transmission for the same call. The same holds true for transmission of the packet-2 message 52 over the data channel 26. As depicted in FIG. 2, the one-slot message 50 is transmitted at a power level as adjusted in accordance with scenario 1, and the packet-2 message 52 represents, for example, a re-transmission of the packet-1 message 38.

In this scenario, the MS 22 fails to properly receive the one-slot message 50 over the control channel 24b, and thus never attempts to decode/demodulate the packet-2 message 52 on the data channel 26. The assumed limit of three slots pass without a reply from the MS 22 to the BS 20 over the R-ACKCH. The BS 20 interprets this lack of timely reply as a failure on the control channel 24b, and adjusts the power margin for the next subsequent transmission over the control channel 24b to that MS 22 by a control power margin up-step 54. The adjusted power margin may also be applied to the control channel 24a. Preferably, the control power margin up-step 54 is greater in absolute terms than the control power margin down-step 46. Since the lack of a timely reply from the MS 22 over the R-ACKCH provides information concerning the control channel 24b, but no information concerning the data channel 26, preferably there is no power margin adjustment for the next subsequent transmission from the BS 20 to the MS 22 over the data channel 26, regardless of whether or not re-transmissions are available.

Scenario 3: ACK Message:

In this third scenario, the BS 20 transmits a four-slot message 56 on the control channel 24a and a corresponding packet-3 message 58, also over four slots, on the data channel 26. The BS 20 preferably transmits the four-slot message 56 and the packet-3 message 58 in parallel. The power margin for this transmission on either channel is as described above. As illustrated, the control and (in certain instances) the data power levels are as adjusted in scenario 2, and the packet-3 message 58 is re-transmissions (or sub-packets) of previous messages.

The MS 22 properly receives the four-slot message 56 over the control channel 24a, determines that the corresponding packet-3 message 58 on the data channel 26 is for it, and properly decodes/demodulates the packet-3 message. In accordance with 1×EV-DV, the MS 22 sends an ACK message 60 over the R-ACKCH 28 within the prescribed time to respond, assumed here as three slots. The BS 20 receives the ACK message 60, determines that there is sufficient and perhaps excess power used to transmit to that MS 22, and adjusts the power margin for the next subsequent transmission to that MS 22 over one or both of the control channel 24a and the data channel 26. The adjusted power margin may also be applied to the control channel 24b. Preferably, power margin for the next subsequent transmission over the control channel 24a (and possibly also control channel 24b) to that MS 22 is decreased by a control power margin down-step 46 (similar to that described with reference to scenario 1), and for the next subsequent transmission over the data channel 26 to that MS 22 is decreased by a data power margin down-step 62.

Preferably, the control power margin down-step 46 (Δ_{C-down}) is related to the control power margin up-step 54 (Δ_{C-up}) and the BLER of the control channel by the following equation:

$${Δ}_{C - down} = \frac{{Δ}_{C - up}}{\frac{1}{BLER} - 1} \qquad ( 1 )$$

For example, if Δ_{C-up}=1 dB, and BLER=1%, then Δ_{C-down}=1/99 dB. An upper limit and lower limit can also be applied to the power margin of the F-PDCCH to prevent unnecessarily high power allocated to the F-PDCCH and too long recovery time from the extreme channel environment. For example, a clipping operation can be performed on the power margin of the control channel. Where the current power margin of the control channel is P_{C-current} that is allowed to vary between a minimum limit P_{C-min} and a maximum limit P_{C-max}, and the next subsequent transmission is to be sent using Pₙₑₓₜ, the following equation set determines Pₙₑₓₜ:

If P_{C-current}+Δ_{C-up}>P_{C-max}; then set Pₙₑₓₜ=P_{C-max};

If P_{C-current}−Δ_{C-down}<P_{C-min}; then set Pₙₑₓₜ=P_{C-min};

Otherwise, set Pₙₑₓₜ=(P_{C-current}+Δ_{C-up}) or (P_{C-current}−Δ_{C-down}) (2)

Once obtaining the power margin, the BS can decide the transmission power of F-PDCCH 24 based on the C/I report.

In a similar manner, an upper limit and lower limit can be applied to the power margin of F-PDCH as well. Once obtaining power margin for the F-PDCH, the BS can decide the transmission format of the F-PDCH based on the C/I report and the available power at the BS.

This adaptive method of adjusting power margin can be extended to the F-PDCH as well if such a power margin is needed. This occurs when retransmission is not viable and a targeted Packet Error Rate (PER) is desired for the F-PDCH 26. One example could be the support of VoIP on the F-PDCH 26. Similar to the operations on the F-PDCCH 24, the power margin of the F-PDCH 26 can be adjusted based on the signal received on the R-ACKCH 28 after the F-PDCCH 24 and F-PDCH 26 were transmitted.

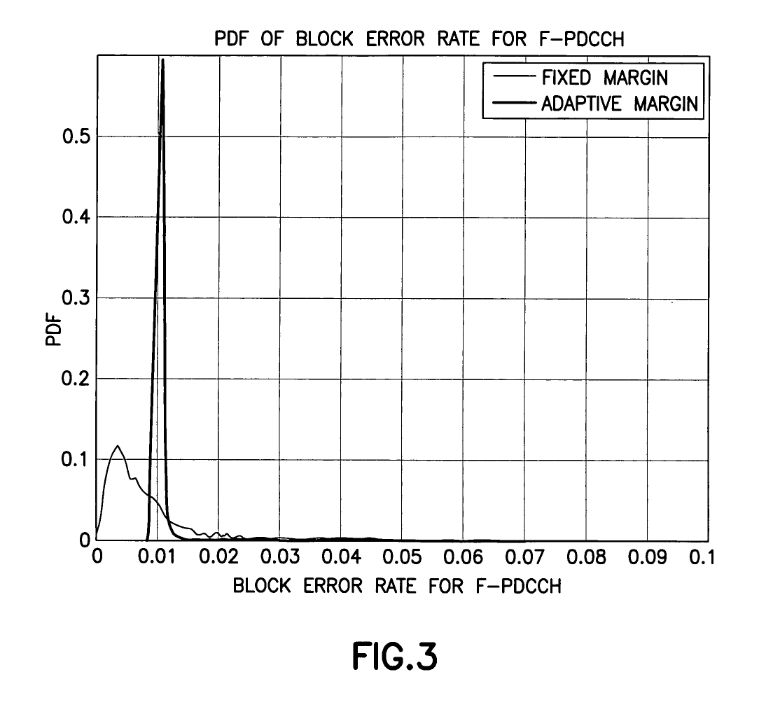

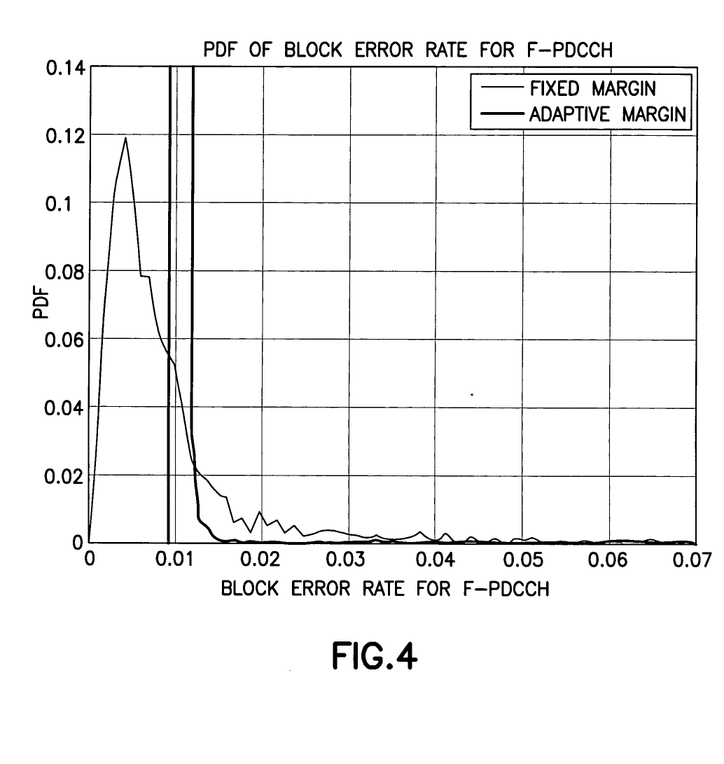

FIGS. 3 and 4 are graphs depicting simulations that were performed to evaluate performance of the invention detailed herein. The simulation set up follows those specified in the simulation strawman (“1×EV-DV Evaluation Methodology—Addendum (V6),” 3GPP2 WG5 Evaluation Ad Hoc, Jul. 25, 2001) and the target BLER of the F-PDCCH 24 is set to 1%. FIG. 3 shows a probability density function (PDF) of the F-PDCCH 24 BLER with the adaptive power margin and that with the fixed power margin. FIG. 3 is the data set from the entire simulation whereas FIG. 4 is an expanded section of FIG. 3 identifiable by the axes labeling. With the adaptive method detailed herein, the BLER of the F-PDCCH 24 is around the target 1% level, which is indicated by the peak around 1% BLER. With the fixed margin of the prior art, on the other hand, the BLER is widely distributed over a range from 0% to around 7%, and an unnecessarily high power margin has to be used in order to combat the C/I inaccuracy caused by factors such as channel variation, C/I report delay, C/I measurement error, and C/I quantization error, as indicated by the large portion of the BLER ranging between 0% and 1%.

In accordance with the above detailed description, the power margin of transmissions over F-PDCCH 24 in 1×EV-DV may be adaptively adjusted to ensure that a targeted BLER is achieved. While the above description also details adjusting power margin for transmissions over F-PDCH 26, it is anticipated that adjustments for the data channel 26 need only be implemented when necessary.

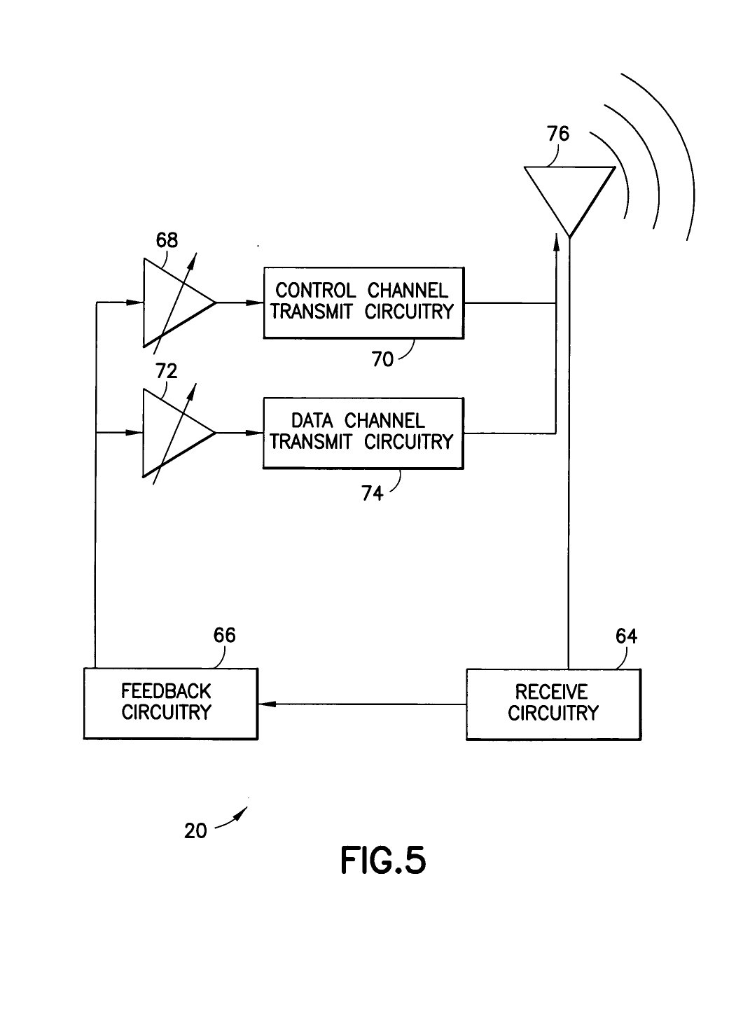

FIG. 5 is a logical block diagram depicting a base station configured according to the preferred embodiment of the present invention that depicts how a BS 20 may adapt power margin to achieve a desired BLER. A BS 20 includes receive circuitry 64 for receiving replies over a reverse channel such as R-ACKCH. The output of the receive circuitry 64 is coupled to an input of feedback circuitry 66, which controls the step size and power margin used to adjust the power level of transmissions to be sent from the BS 20. Either the receive circuitry 64 or the feedback circuitry 66 determines the direction of a power margin adjustment, if any, based on the content of a reply message or based on the absence of a reply message within a prescribed time period. The output of the feedback circuitry 66 is coupled to an input of a control channel power control circuit 68, and preferably also to a data channel power control circuit. The size of the control power margin up-step 54 and down-step 46 may be adjusted at the control channel power control circuit 68 or at the feedback circuitry 66. Similarly, the size of the data power margin up-step 48 and down-step 62 may be adjusted at the data channel power control circuit 72 or at the feedback circuitry 66. Outputs from the power control circuits 68, 72 are coupled to inputs to transmit circuitry 70, 74, for the control channel and the data channel, respectively. Signals output from the control channel transmit circuitry 70 and the data channel transmit circuitry 74 are transmitted over one or more antenna 76 to a mobile station 22. Using the equation (1) and equation set (2) above, or similar such relations, a desired BLER may be input at the feedback circuit 66, causing a change in the size of an up-step and/or down-step for either or both channels to effect that desired BLER.

The present invention requires no information of the channel environment and slot duration of the F-PDCCH 24. Due to the adaptive nature of this method, it can track the change of the channel environment more accurately compared to the one with fixed margin, hence be able to more closely maintain the BLER of the F-PDCCH at the targeted level. If the wireless operator chooses to change the BLER of the F-PDCCH 24, the operator need only adjust the ratio of the control power margin up-step 54 to the control power margin down-step 46 (or the ratio of data power margin up-step 48 to data power margin down-step 62), such as by the arrangement of FIG. 5. Conversely, the prior art requires generation of new power margin table for the new targeted BLER, which typically involves extensive testing or simulations.

While described in the context of presently preferred embodiments, those skilled in the art should appreciate that various modifications of and alterations to the foregoing embodiments can be made, and that all such modifications and alterations remain within the scope of this invention. Examples herein are stipulated as illustrative and not exhaustive.

What is claimed is:

1. A method for transmitting a message in a CDMA environment at a power level determined using an adaptive power margin comprising:
transmitting a first message on a first channel at a first power level determined using a first power margin;
monitoring a reply channel for a reply message;
determining a second power margin for a next subsequent transmission on the first channel based on one of a content of the reply message or an absence of the reply message within a prescribed period of time, wherein the second power margin may differ from the first power margin; and
transmitting a second message at a power level determined using the second power margin.

2. The method of claim 1 wherein the first message and the second message relate to a single call to a mobile station.

3. The method of claim 1 wherein the first message on the first channel comprises a control message on a forward control channel that corresponds to a first data message transmitted on a separate forward data channel, and wherein the second power margin is lower than the first power margin when the content of the reply message indicates proper reception of the control message.

4. The method of claim 1 wherein the second power margin is higher than the first power margin when the reply message is not received within the prescribed period of time.

5. The method of claim 1 wherein the difference between the first power margin and the second power margin is adjusted to impose a targeted error rate.

6. The method of claim 1 wherein determining a second power margin further comprises at least one of
setting the second power margin lower than the first power margin if the reply message indicates reception of at least the first message; and
setting the second power margin higher than the first power margin if the reply message is not received within the prescribed time period.

7. The method of claim 6 wherein the difference between the first power margin and the lower second power margin is Δ_{down}; further wherein the difference between the first power margin and a higher second power margin is Δᵤₚ, and at least one of Δ_{down} and Δᵤₚ is set to achieve a targeted error rate.

8. The method of claim 1 wherein the second power margin differs from the first power margin in each instance during a call when a reply message is expected.

9. The method of claim 1 wherein
transmitting a first message further comprises transmitting in parallel a corresponding first data message on a data channel at a data power level determined using a first data power margin, and wherein
transmitting a second message further comprises transmitting in parallel a corresponding second data message on a data channel at a data power level determined using a second data power margin, and further wherein
determining a second power margin further comprises determining the second data power margin, wherein the difference between the first data power margin and the second data power margin differs in direction from the difference between the first power margin and the second power margin for at least one content of the reply message.

10. The method of claim 9 wherein determining a second power margin further comprises at least one of:
setting the second power margin lower than the first power margin and setting the second data power margin higher than the first data power margin when the content of the reply message indicates reception of the first message but not the first data message; and
setting the second power margin higher than the first power margin and setting the second data power margin equal to the first data power margin when a reply message is not received within the prescribed time period.

11. A method for adaptively controlling a power margin used to determine a power level of a transmission from a base station to a mobile station during a call in a spread spectrum environment, comprising:
transmitting in parallel, from a base station (BS),
a first control message over a forward control channel PDCCH at a power level determined using a first control power margin and
a first data message over a forward data channel PDCH at a power level determined using a first data power margin;
monitoring a reverse acknowledgment channel ACKCH;
determining a second control power margin that differs from the first control power margin based on one of a content of a reply received over the ACKCH or an absence of a reply during a prescribed time period; and
transmitting in parallel, from the BS, a second control packet subsequent to the first control packet over the PDCCH at a power level determined using the second control power margin.

12. The method of claim 11 wherein determining a second control power margin further comprises at least one of:
decreasing the second control power margin respecting the first control power margin when the content of the reply comprises a NACK message;
increasing the second control power margin respecting the first control power margin when no reply message is received within the prescribed time period; and
decreasing the second control power margin respecting the first control power margin when the content of the reply comprises an ACK message.

13. The method of claim 12 wherein determining a second control power margin further comprises determining a data power level determined using a second data power margin at which a second data packet is transmitted over the PDCH, and wherein determining the second data power margin comprises at least one of:
increasing the second data power margin respecting the first data power margin when the content of the reply comprises a NACK message;
setting the second power margin equal to the first data power margin when no reply message is received within the prescribed time period; and
decreasing the second data power margin respecting the first data power margin when the content of the reply comprises an ACK message.

14. The method of claim 12 wherein decreasing the second control power margin respecting the first control power margin is by an amount Δ_{down}; and wherein increasing the second control power margin respecting the first control power margin is by an amount Δᵤₚ; and wherein an error rate is set by adjusting the ratio of Δ_{down}/Δᵤₚ.

15. The method of claim 14 wherein the error rate is a block error rate BLER, and wherein the BLER is related to the ratio by
$${Δ}_{down} = \frac{{Δ}_{up}}{\frac{1}{BLER} - 1} .$$

16. In a base station for transmitting packet data to at least one mobile station within a designated geographic cell having first transmit circuitry for transmitting over a control channel, power control circuitry for setting a transmission power for transmissions over the control channel, the transmission power determined using a power margin, second transmit circuitry for transmitting over a data channel, and reception circuitry for receiving signals over a reply channel, the improvement comprising:
a feedback circuit connecting an output of the reception circuitry to an input of the power circuitry for adjusting the power margin during a call based on a content of a signal received over the reply channel.

17. The base station of claim 16 wherein the base station operates using at least code division multiple access, and where the control channel is a F-PDCCH, the data channel is a F-PDCH, and the reply channel is a R-ACKCH.
